(19) United States
(12) Patent Application Publication
(10) Pub. No.: US 2016/0057496 A1
(43) Pub. Date: Feb. 25, 2016

(54) CONTENT RECOMMENDATIONS

(71) Applicant: Rovi Technologies Corporation, Santa Clara, CA (US)

(72) Inventors: Anuranjita Tewary, Mountain View, CA (US); Jonathan L. Conradt, San Jose, CA (US)

(21) Appl. No.: 14/810,195

(22) Filed: Jul. 27, 2015

Related U.S. Application Data
(62) Division of application No. 11/716,958, filed on Mar. 12, 2007, now abandoned.

(51) Int. Cl. H04N 21/466; H04N 21/475; H04N 21/4788; H04N 21/25

(52) U.S. Cl. CPC H04N 21/4668; H04N 21/252; H04N 21/4756; H04N 21/4788

(57) ABSTRACT

Content recommendations are described. In an implementation, feedback collected from a user is used to determine favored characteristics of particular items of musical content. One or more other items of content, which are not music, are identified that correspond to the favored characteristics. The identified one or more other items of content are recommended to the user.

### BACKGROUND

A user may employ a variety of devices that utilize a variety of techniques to interact with content. For example, the user may record television programs or purchase video-on demand using a set-top box; listen to a particular song on a portable music player, via a car stereo or streamed over a television channel to the set-top box; and so on. Thus, the user may access a variety of content from a single device (e.g., the set-top box) and may also access similar content using a variety of devices (e.g., listening to the particular song by the portable music player, the car stereo or the set-top box).

Traditional techniques that were used to recommend content to users, however, were typically focused on the particular type of the content and/or the device used to interact with the content, even though the user may use a variety of devices to interact with a variety of content as previously described. For example, a purchaser of a particular song to be played on a portable music player may receive a recommendation of another song that might be of interest. Likewise, a renter of a particular movie may receive a recommendation of another movie. This focus was typically a result of the limited interaction of the user with a particular service that made the recommendation and therefore did not address the variety of devices and techniques that the user may utilize to interact with content.

### SUMMARY

Content recommendations are described. In an implementation, feedback collected from a user is used to determine favored characteristics of particular items of musical content. One or more other items of content, which are not music, are identified that correspond to the favored characteristics. The identified one or more other items of content are recommended to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to provide content recommendations.

FIG. 2 is an illustration of a system in an exemplary implementation showing clients and a content provider of FIG. 1 in greater detail.

FIG. 3 is a flow diagram depicting a procedure in an exemplary implementation in which user feedback is collected regarding particular items of musical content and used to recommend one or more other items of content to the user.

FIG. 4 is a flow diagram depicting a procedure in an exemplary implementation in which a library of content is shared and leveraged to make content recommendations.

FIG. 5 is a flow diagram depicting a procedure in an exemplary implementation in which metadata indicating a general location of where an image was taken is used to provide one or more recommendations based on the general location.

### DETAILED DESCRIPTION

### Overview

Users may utilize a diverse range of devices (e.g., portable music players, personal computers, car stereos) to access a variety of different types of content (e.g., video-on-demand, music, television programs and movies). Traditional techniques that were used to make recommendations regarding this content (e.g., another particular item of content that may be of interest, such as a movie rental), however, did not address this range of devices or other types of content when making recommendations.

Techniques are described which may be used to provide recommendations utilizing a variety of different criteria. For example, a user may have an interest in viewing television appearances by favorite musicians. However, these appearances may occur on a variety of different types of television programs, such as late-night variety shows, daytime talk shows, televised award shows, video music channels, and so on. Therefore, it was traditionally difficult for the user to gather information on each of the different appearances, the difficulty of which is further compounded as the user tried to track multiple musicians.

Accordingly, a recommendation technique may be employed in which the user's music library is scanned and analyzed to determine the user's favorite musicians, genres and so on from the songs contained in a music library. Recommendations may then be made based on this information. For example, this music library may be shared by a personal computer and a set-top box. Recommendations may be made regarding television programs to record based on favored characteristics of songs in the music library, such as a rating assigned to the songs, frequency of playback, and so on.

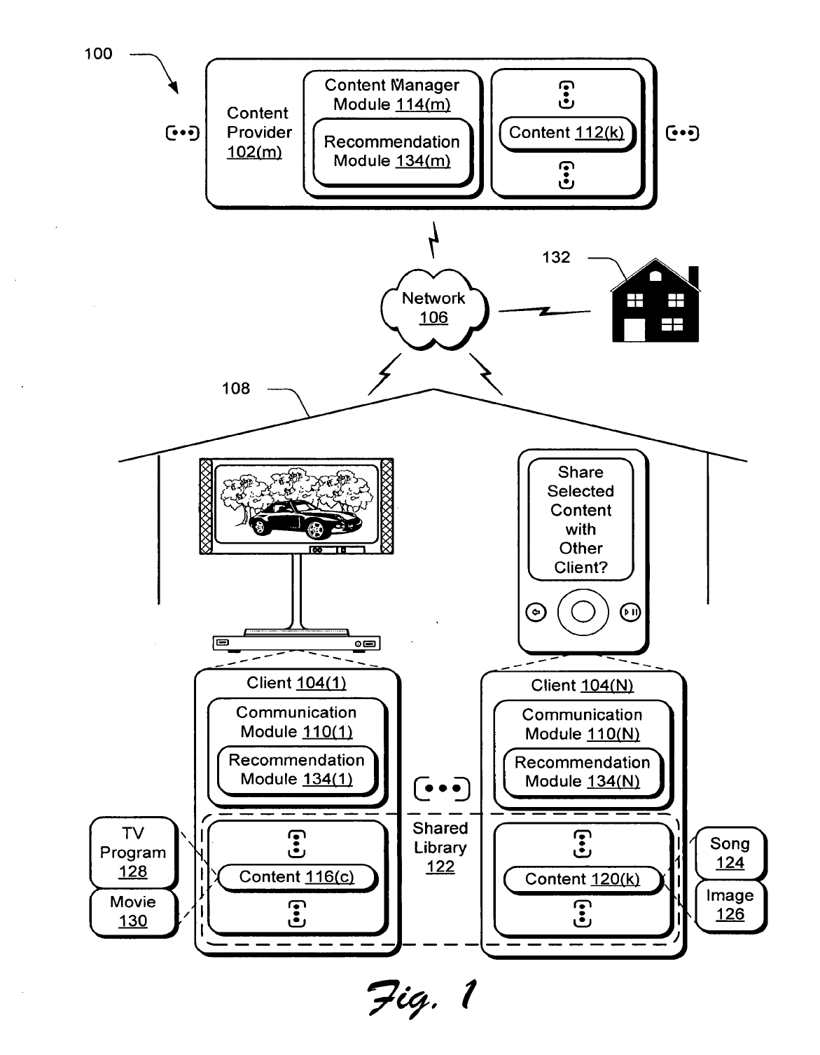

For instance, a determination may be made of the user's favorite artists based on a “star” rating of songs in the shared library. The set-top box may then “look” for appearances by those artists in an electronic program guide and record television programs having those artists. Thus, in this instance the recommendation results in automatic recordation of the television programs by the set-top box through use of an electronic program guide. A variety of other instances are also contemplated. Further discussion of recommendations based on musical content and shared libraries may be found in relation to FIGS. 1-4.

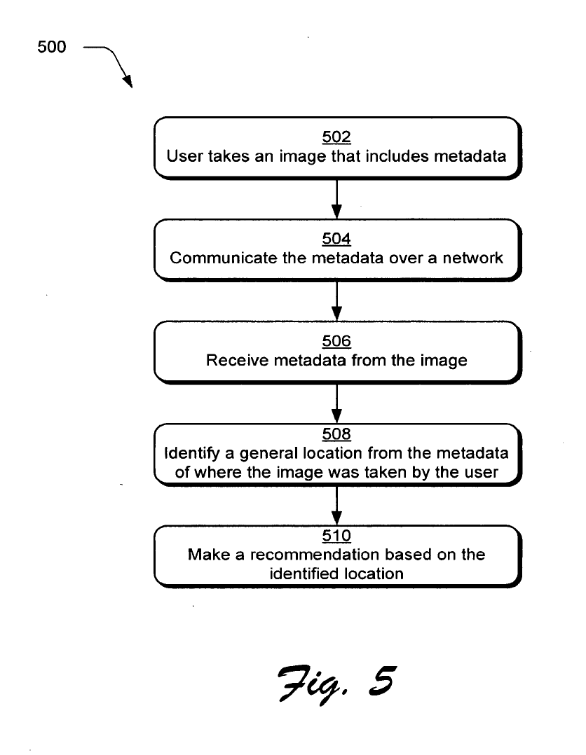

Another technique involves providing recommendations based on where an image was taken by a user. The user, for instance, may take a digital picture during a football game of a particular play. Metadata (e.g., a tag) may be stored with the image that describes the location, which may include textual data stored by the user e.g., “Football Championship Game”, Global Positioning System (GPS) coordinates, and so on. The general location of where the image was taken may then be used to make recommendations, such as to locate other images of the football game taken by other users, suggest merchandise, and so on. Further, the time of day may also be used, such as to locate other images taken by other users of the particular play of the football game. A variety of other examples are also contemplated, further discussion of which may be found in relation to FIG. 5.

In the following discussion, an exemplary environment is first described that is operable to provide recommendations. Exemplary procedures are then described which are operable in the environment, as well as in a variety of other environments.

### Exemplary Environment

FIG. 1 is an illustration of an environment 100 in an exemplary implementation that is operable to provide content recommendations. The illustrated environment 100 includes one or more content providers 102(m) (where “m” can be any integer from one to “M”) and a plurality of clients 104(1)-104(N) that are communicatively coupled, one to another, over a network 106.

The clients 104(1)-104(N) may be configured in a variety of ways. For example, the clients 104(1)-104(N) may be configured as a computer that is capable of communicating over the network 106, such as a desktop computer, a mobile station, an entertainment appliance, a set-top box communicatively coupled to a display device (e.g., as illustrated for client 104(1)), a wireless phone, a game console, a portable music player (e.g., as illustrated for client 104(N)) and so forth. For purposes of the following discussion, the clients 104(1)-104(N) may also relate to a person and/or entity that operate the clients. In other words, clients 104(1)-104(N) may describe logical clients that include users and/or devices.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks. For instance, the clients 104(1)-104(N) are illustrated as included within a residential environment 108. In this instance, the clients 104(1)-104(N) may be communicatively coupled, one to another, over a local area network. The clients 104(1)-104(N) may also be communicatively coupled to the content provider 102(m) over the Internet, such as through a residential gateway. A variety of other instances are also contemplated.

Each of the clients 104(1)-104(N) is illustrated as including a respective communication module 110(1)-110(N) which is representative of functionality to interact with content. Client 104(1), for instance, is illustrated as a set-top box that may receive content 112(k) (where “k” can be any integer from one to “K”) from the content provider 102(m) over the network 106. The content provider 102(m) in this instance may be configured as a network operator that executes a content manager module 114(m) to stream content over the network 106 to the client 104(1), such as television programs, video-on-demand, musical content, and so on. The client 104(1) may then output the content 112(k) as it is received and/or store it locally, which is illustrated as content 116(c) (where “c” can be any integer from one to “C”). Content 116(c) at client 104(1) may also be representative of content that may be obtained locally at the client 104(1), such as via a digital video disc (DVD). Thus, the client 104(1) may have access to a wide range of content.

Likewise, client 104(N) may also include a wide variety of content, which is illustrated as a portable music player in FIG. 1. For example, the client 104(N) may execute the communication module 110(N) to purchase content 112(k) from the content provider 102(m) over the network 106, such as songs, music videos, and so on. The content 112(k) may then be communicated to the client 104(N) for local storage as content 118(d), where “d” can be any integer from one to “D”. The content 118(d) may also be representative of a variety of other content, such as images (e.g., digital photographs).

Thus, as previously described a wide variety of content may be made available to a user using a wide variety of devices. Because of this variety, a technique has been developed to provide a shared library 122 such that the clients 104(1)-104(N) may share content, one with another. For example, content 120(k) (e.g., song 124, image 126) of the client 104(N) may be accessible by client 104(1) for output, such as streamed from client 104(N) over a local network connection for output by client 104(1), copied to local storage of client 104(1) and then output, and so on. Likewise, content 116(c) (e.g., a TV program 128 and movie 130) may be shared with the client 104(N). Further, in an implementation the shared library 122 is not limited to sharing between clients 104(1)-104(N) in the residential environment 108, but may also include client over the network 106, such as in another residence 132. A variety of other examples are also contemplated.

The environment 100 is also illustrated as including recommendation modules 134(1)-134(N), 134(m) which are representative of functionality to provide recommendations based on a variety of factors. The recommendation modules 134(1)-134(N), 134(m) are depicted through the environment 100 to illustrate that the corresponding functionality may be incorporated by the clients 104(1)-104(N), the content provider 102(m) or elsewhere (e.g., a stand-alone service). The recommendation modules 134(1)-134(N) may make recommendations in a variety of ways.

For example, the residential environment 108 may share content 116(c), 120(k) between the clients 104(1)-104(N) using the shared library 122. This content 116(c), 120(k) within the shared library 122 may be used as a basis to make recommendations. For instance, the content 116(c), 120(k) may include songs by Bruce Springsteen, Mozart and Beethoven that are rated higher by a user than other songs. The recommendation module 134(1) of the client 104(1) may thus determine which of the content is favored and identify favored characteristics that describe the content 116(c), 120(k), such as “classical” for genre and “Springsteen”, “Beethoven” and “Mozart” for artists. The recommendation module 134(1) may then query an electronic program guide to locate television programs having those favored characteristics, such as a performance by the Boston Pops of a Beethoven symphony, a retrospective about Bruce Springsteen, and so on. Recommendations may then be based on these identified television programs, such as to automatically record these programs by the client 104(1) to local storage (e.g., as a digital video recorder), suggest these programs to a user of the client 104(1), and so on. Thus, in this example recommendations for one type of content (e.g., television programming) may be based on another type of content (e.g., songs). A variety of other examples are also contemplated.

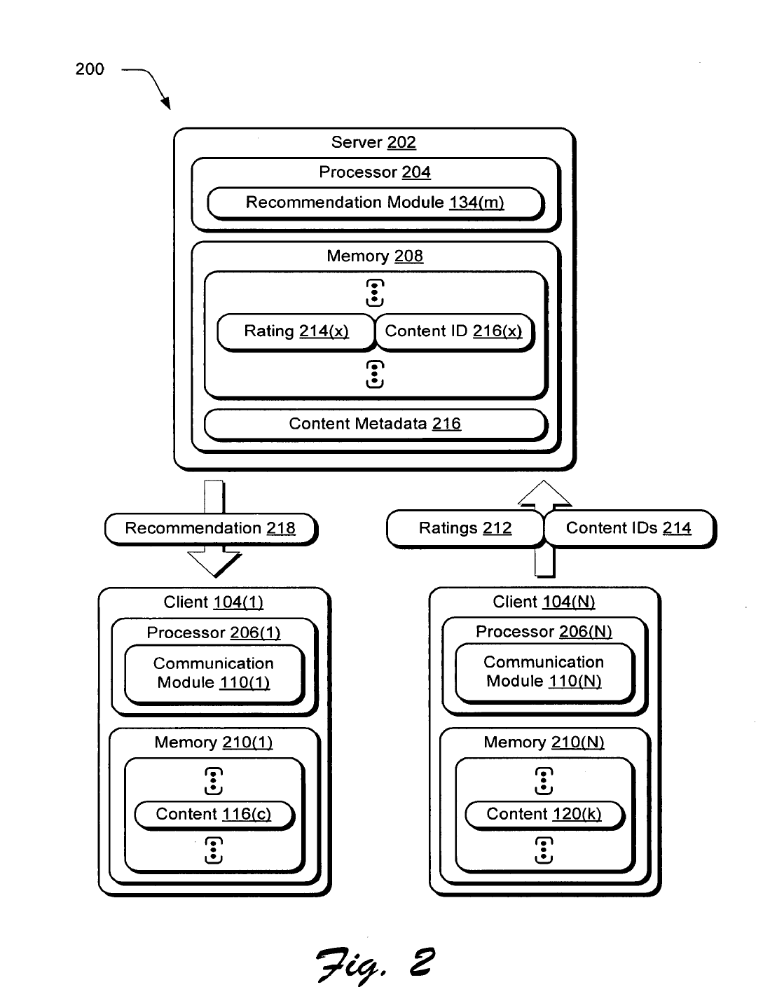

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the content recommendation techniques described below are platform-independent, meaning that the techniques may be implemented on a variety of commercial computing platforms having a variety of processors.

FIG. 2 is an illustration of a system 200 in an exemplary implementation showing the clients 104(1)-104(N) of FIG. 1 in greater detail. A recommendation module 134(m) of the content provider 102(m) is illustrated as being implemented via a server 202 and the clients 104(1)-104(N) are illustrated as client devices, e.g., a computer. Accordingly, the server 202 and the clients 104(1)-104(N) are illustrated as having respective processors 204, 206(1)-206(N) and memory 208, 210(1)-210(N).

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 208, 210(1)-210(N) is shown, respectively, for the server 202 and the clients 104(1)-104(N), a wide variety of types and combinations of memory may be employed, such as random access memory (RAM), hard disk memory, removable medium memory, and other types of computer-readable media.

Client 104(N) is illustrated as providing ratings 212 and content IDs 214 to the server 202. For example, the ratings 212 may be “star” ratings (e.g., a scale of “1” to “5”) and the content IDs 214 may be “ID3” identifiers (i.e., a tag embedded in MPEG 1 Layer III files) that identify artist and release information of corresponding content. The ratings 212 and content IDs 214 may be stored in the memory 208 with other ratings 212(x) and content IDs 214(x) obtained from the same client 104(N) and or different clients, e.g., client 104(1), clients from another residence 132, and so on.

The recommendation module 134(m) may then be executed on the processor 204 (which is also storable in memory 208) to determine favored characteristics of content 120(k) of the client 104(N), such as favorite artists, genres, and so on. These favored characteristics may then be used by the recommendation module 134(m) to examine content metadata 216 that describes other content. The content metadata 216 may be configured in a variety of ways, such as electronic program guide data, data included with musical content (e.g., the IP3 identifiers as previously described), image metadata (e.g., format, where and when an image was taken), and so on.

The examination may then be used to form a recommendation 218 that is communicated to another client, such as client 104(1) configured as a set-top box in FIG. 1. The recommendation 218 may be formed in a variety of ways, such as to cause the client 104(1) to record television programs located in the content metadata 216 as having matching or similar favored characteristics, such as a favorite artist as previously described. The recommendation 218 may also be output as a suggestion to give the client 104(1) the option of recording the identified “other” content having the favored characteristics. A variety of other examples are also contemplated, further discussion of which may be found in relation to the following exemplary procedures.

### Exemplary Procedures

The following discussion describes content recommendation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

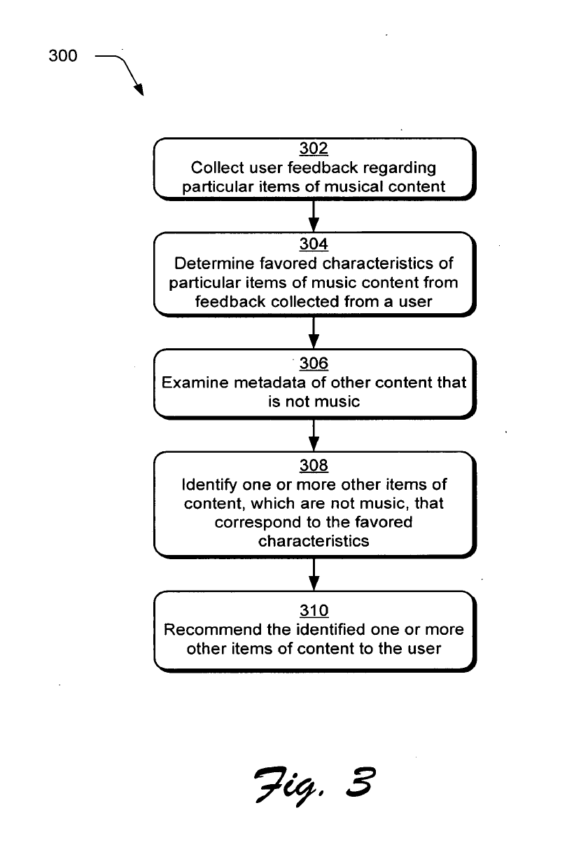

FIG. 3 depicts a procedure 300 in an exemplary implementation in which user feedback is collected regarding particular items of musical content and used to recommend one or more other items of content to the user. User feedback is collected regarding particular items of musical content (block 302), such as through execution of a communication module 110(1) by a respective client 104(1).

The feedback may be configured in a variety of different ways. For example, the user may manually input a rating when the communication module 110(1) is configured as a media player application that collects “star” ratings. Usage data may also be used to provide feedback, such as a number of times a user selected the musical content to be output, frequency of the output of the musical content, and so on. For instance, the client 104(N) illustrated as a portable music player may include a wireless connection that enables the client 104(N) to “share” content 120(k) with other clients, such as to output the content 120(k) a predetermined number of times. By tracking which content 120(k) is shared by the client 104(N), feedback may be provided which indicates which content 120(k) is considered favorable. A variety of other examples are also contemplated.

The favored characteristics of particular items of music content are determined from the feedback collected from the user (block 304). The recommendation module 134(m), for instance, may identify particular characteristics that are common in two or more items of content, such as artist, genre, writer, and so on.

Metadata of other content that is not music is then examined (block 306). The other content may be of a different type, such as a television program, video-on-demand, image, and so on. For example, the recommendation module 134(m) may examine EPG data that describes characteristics of television programs, textual descriptions of books, reviews of video-on-demand, and so on.

One or more other items of content, which are not music, are identified that correspond to the favored characteristics (block 308), such as an autobiography of a favorite musician, a video-on-demand of the musician in concert, and so on.

The identified one or more other items of content are then recommended to the user (block 310). For example, the client 104(1) configured as a set-top box may be set to output a suggestion to the user that the video-on-demand of the musician in concert is available, highlight the video-on-demand in an EPG, and so on. In this way, the recommendation module's 134(m) “knowledge” of the user's feedback regarding the musical content may be leveraged to recommend other content. A variety of other examples are also contemplated, further discussion of which may be found in relation to the following figure.

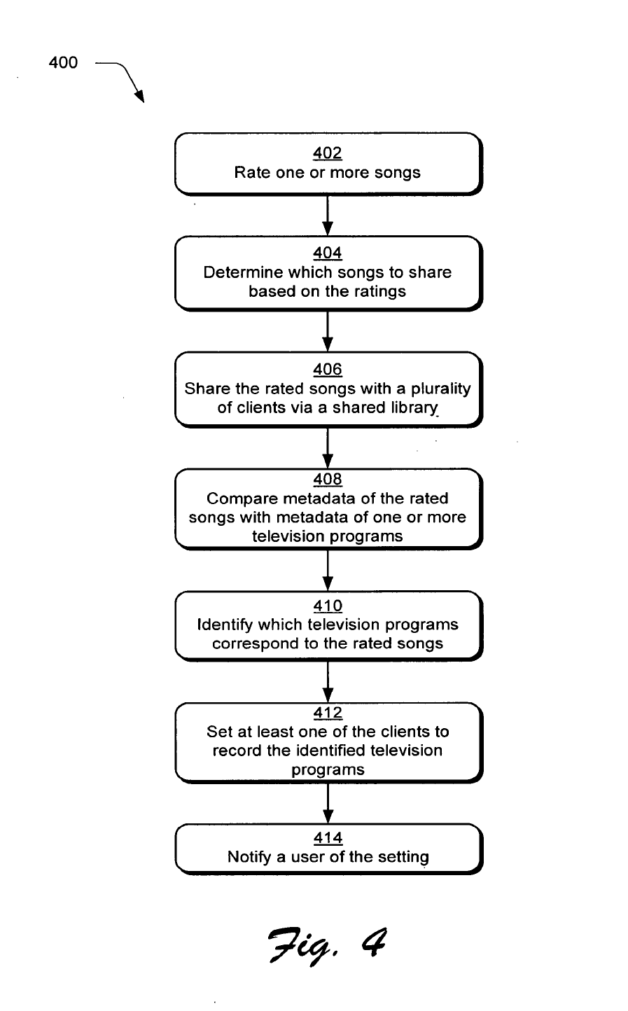

FIG. 4 depicts a procedure 400 in an exemplary implementation in which a library of content is shared and leveraged to make content recommendations. One or more songs are rated (block 402). For example, a user may interact with a media player application being executed on a personal computer to assign a “star” rating to one or more songs, such as “four” or “five” stars to songs the user favors as opposed to “one” or “two” stars to disliked songs.

A determination is then made as to which songs are to be shared based on the ratings (block 404) and are then shared based on the rating (block 406). Continuing with the previous example, the media player application may decide which songs to share with another client (e.g., client 104(1) configured as a set-top box in FIG. 1) such that favorite songs are accessible by the other client. The sharing may be performed in a variety of ways, such as by copying the songs to the other client, providing access to the songs that are stored on the personal computer, and so on. Thus, in this example the set-top box is made aware of the user's favorites through use of a shared library 122. This awareness may be leveraged in a variety of ways.

The set-top box, for instance, may communicate data which describes the ratings to the server 202 of the content provider 102(m). The server may then compare metadata of the rated songs with metadata of one or more television programs (block 408), such as through comparison with EPG data. Through this comparison, the server may identify which television programs correspond to the rated songs (block 410). Continuing with the previous example, the recommendation module 134(m) may locate artists for musical content (e.g., songs) with a star rating of “4” or higher from the feedback provided by the user. The recommendation module 134(m) may then identify television programs that have those artists.

At least one of the clients may then be set to record the identified television programs (block 412) and the user is notified of the setting (block 414). Client 104(1), for instance, may receive a recommendation configured as an extensible markup language (XML) document that describes the television programs to be recorded. The communication module 110(1) of the client 104(1) may then schedule the appropriate recordings upon parsing the document. Thus, in this example the music is leveraged to provide television program recommendations. A variety of other examples are also contemplated.

For example, a video game may be recommended based on music demographic information obtained through analysis of which music the client 104(N) typically outputs. Certain songs, for instance, may indicate a user may be interested in a particular type of video game, such as a sports video game based on music that is commonly played at sporting events and/or listened to by people that attend the sporting events. In another example, a user may have recorded two movies in a particular series and therefore a soundtrack of songs may be recommended to the user. In yet another example, tastes in similar music may be used by a dating website to recommend other users that have similar tastes.

In a further example, a communication module (e.g., a browser) of a client configured as a personal computer may detect that the user has customized a personal web page that includes images taken by a user. These images, and the metadata associated therewith, may then be used to recommend other content. For instance, digital images included in the personalized webpage that have associated metadata indicating that the image was taken in Hawaii may be used to recommend vacation offers, ring tones for the user's wireless phone, television programs filmed in Hawaii (e.g., “Lost”), and so on, such as through advertisements on the personalized webpage itself. Further discussion of image metadata that may be leveraged to provide recommendations may be found in relation to the following figure.

FIG. 5 depicts a procedure 500 in an exemplary implementation in which metadata indicating a general location of where an image was taken is used to provide one or more recommendations based on the general location. A user takes an image that includes metadata (block 502). The image, for instance, may be taken through use of a digital camera and the metadata may identify a general location of where the image was taken, such as a textual description input by a user (e.g., “Hawaii”), global positioning system (GPS) coordinates, and so on.

The metadata is communicated over a network (block 504), such as to a server 202 of FIG. 2, which receives the metadata from the image (block 506). The general location is identified from the metadata of where the image was taken by the user (block 508) and a recommendation is made based on the identified location (block 510). These steps may be performed in a variety of ways.

The user, for instance, may upload the image to website that is used to share the image with other users, such as an image sharing website (e.g., a “photo vault”), a personable web log (i.e., “blog”), and so on. Metadata associated with the image, such as the GPS coordinates or textual description may then be used to make one or more recommendations. For example, the recommendations may identify other images taken from that location, such as another image taken of a scene.

The recommendation may also identify other images taken “at the same time” when the metadata includes time information, such as to find another image of a particular play that occurred during a football game. The use of “time and place” may also be used to provide merchandise, such as merchandise regarding a particular event that took place at the location, e.g., the Superbowl, although it should be apparent that general location information by itself may also be utilized to make merchandise suggestions, e.g., Hawaiian shirts and mugs for pictures from Hawaii. Similar techniques may also be employed to recommend services based on the general location, such as services that may be made available at the general location, to travel to the general location, and so on. A variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method for recommending non-musical content comprising:
receiving, from one or more devices associated with a user, frequencies of playback of each of a first plurality of musical content items on each device associated with the user;
identifying, based on the received frequencies of playback, a second plurality of musical content items from the first plurality of musical content items, the second plurality of musical content items comprising musical content preferred by the user;
identifying characteristics common to at least two of the second plurality of musical content items;
determining, based on the identified common characteristics, characteristics of musical content preferred by the user;
comparing metadata associated with each item of a plurality of non-musical content items with the identified common characteristics of musical content preferred by the user;
based on the comparing, identifying an item of the plurality of non-musical content items that matches the characteristics preferred by the user; and
recommending the identified item of the plurality of non-musical content items to the user.

2. A method as described in claim 1, wherein the recommended item of the plurality of non-musical content items is one of a video, video game, non-musical audio, and image.

3. A method as described in claim 1, wherein
the first plurality of musical content items is accessible via a shared library.

4. A method as described in claim 1, further comprising:
receiving, from the one or more devices associated with the user, ratings for particular items of the first plurality of musical content items; and
identifying, based on the received ratings, the second plurality of musical content items.

5. A method as described in claim 4, wherein identifying, based on the received ratings, the second plurality of musical content items comprises:
retrieving a threshold rating; and
adding to the second plurality of musical content items those items that meet or exceed the threshold rating.

6. A method as described in claim 1, wherein the identified common characteristics are selected from a group consisting of:
artist;
time;
album;
song; and
genre.

7. A method as described in claim 1, further comprising:
receiving, from the one or more devices associated with the user, frequencies of sharing of each item of the first plurality of musical content items; and
identifying, based on the received frequencies of sharing, the second plurality of musical content items.

8-20. (canceled)

21. A method as described in claim 1, wherein recommending the identified item of the plurality of non-musical content items to the user comprises:
determining that the identified item of the plurality of non-musical content items is a television program; and
automatically recording the television program.

22. A method as described in claim 1, wherein identifying the characteristics common to the at least two items of the second plurality of musical content items further comprises accessing a tag embedded in a file associated with an item of the second plurality of musical content items, wherein data within the tag identifies a common characteristic.

23. A method as described in claim 1, further comprising:
receiving common characteristics of musical content preferred by a different user, wherein the user and the different user are both members of a dating website;
comparing the common characteristics of musical content preferred by the user with the common characteristics of musical content preferred by the different user; and
based on determining that the common characteristics of musical content preferred by the user and the common characteristics of musical content preferred by the different user match, transmitting an indication of a match to the dating website.

24. A system for recommending non-musical content comprising:
control circuitry configured to:
receive, from one or more devices associated with a user, frequencies of playback of each of a first plurality of musical content items on each device associated with the user;
identify, based on the received frequencies of playback, a second plurality of musical content items from the first plurality of musical content items, the second plurality of musical content items comprising musical content preferred by the user;
identify characteristics common to at least two of the second plurality of musical content items;
determine, based on the identified common characteristics, characteristics of musical content preferred by the user;
compare metadata associated with each item of a plurality of non-musical content items with the identified common characteristics of musical content preferred by the user;
based on the comparing, identify an item of the plurality of non-musical content items that matches the characteristics preferred by the user; and
recommend the identified item of the plurality of non-musical content items to the user.

25. A system as described in claim 24, wherein the recommended item of the plurality of non-musical content items is one of a video, video game, non-musical audio, and image.

26. A system as described in claim 24, wherein the first plurality of musical content items is accessible via a shared library.

27. A system as described in claim 24, wherein the control circuitry is further configured to:
receive, from the one or more devices associated with the user, ratings for particular items of the first plurality of musical content items; and
identify, based on the received ratings, the second plurality of items of musical content.

28. A system as described in claim 27, wherein the control circuitry is further configured, when identifying, based on the received ratings, the second plurality of musical content items, to:
retrieve a threshold rating; and
add to the second plurality of musical content items those items that meet or exceed the threshold rating.

29. A system as described in claim 24, wherein the identified common characteristics are selected from a group consisting of:
artist;
time;
album;
song; and
genre.

30. A system as described in claim 24, wherein the control circuitry is further configured to:
receive, from the one or more devices associated with the user, frequencies of sharing of each item of the first plurality of musical content items; and
identify, based on the frequencies of sharing, the second plurality of musical content items.

31. A system as described in claim 24, wherein the control circuitry is further configured, when recommending the identified item of the plurality of non-musical content items to the user, to:
determine that the identified item of the plurality of non-musical content items is a television program; and
automatically record the television program.

32. A system as described in claim 24, wherein the control circuitry is further configured, when identifying the characteristics common to the least two items of the second plurality of musical content items, to:
access a tag embedded in a file associated with an item of the second plurality of musical content items, wherein data within the tag identifies a common characteristic.

33. A system as described in claim 24, wherein the control circuitry is further configured to:
receive common characteristics preferred by a different user, wherein the user and the different user are both members of a dating website;
compare the common characteristics preferred by the user and the common characteristics preferred by the different user; and
based on determining that the common characteristics preferred by the user and the common characteristics preferred by the different user match, transmit an indication of a match to the dating website.
